(19) United States
(12) Patent Application Publication
(10) Pub. No.: US 2009/0067657 A1
(43) Pub. Date: Mar. 12, 2009

(54) SPEAKER-EMBEDDABLE SEAT AND PERSONAL AUDIO SYSTEM

(75) Inventors: Mitsuo Yasushi, Saitama (JP); Masatoshi Yanagidaira, Saitama (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/909,924

(22) PCT Filed: Mar. 14, 2006
(86) PCT No.: PCT/JP2006/305050

§ 371 Date: Sep. 27, 2007

(30) Foreign Application Priority Data
Mar. 30, 2005 (JP) 2005-098871

(51) Int. Cl. H04R 1/02

(52) U.S. Cl. 381/333

(57) ABSTRACT

A speaker-embeddable seat includes a first speaker that outputs low-frequency sound and is arranged in a seat, and a second speaker that outputs middle-frequency to high-frequency sound and is arranged in a backrest at a position near ears of a seated person. The first speaker is acoustically coupled to a position near ears of a seated person through a duct extending in the backrest, so that low-frequency sound output from the woofer is transmitted to the position. The first speaker, the second speaker, and a front speaker arranged anterior to the speaker-embeddable seat form a sound field. Audio signals that are to be output from the front speaker and the second speaker are subjected to reverberation processing and frequency characteristic conversion so that a sound image is localized anterior to the head of a seated person.

### TECHNICAL FIELD

The present invention generally relates to a speaker-embeddable seat. The present invention specifically relates to a speaker-embeddable seat with built-in woofer.

### BACKGROUND ART

A technology is known that transmits a difficult-to-hear low-frequency sound through the skin or bones of a human body (hereinafter sometimes referred to as “body-felt sound”) thereby providing a more real sound. An example of such technology is “Bodysonic” (product name) that is a seat with an embedded electrical-vibration converter.

Such body-felt sound seat is not only popular among audio enthusiasts, but also applied in promoting rehabilitation in the field of medical welfare, and used as a complementary sensitivity apparatus that functions as a sensitivity simulator in amusement industry or education industry.

In a conventional body-felt sound seat, a pillow speaker is attached near to the ears of a person seated in the seat. A vibrator is in a cushion provided at the back and under the hips. A low-frequency sound is converted into vibrations and transmitted to the back and the hips via the vibrator (refer to, for example, Patent Documents 1 to 4).

Patent Document 1: Utility Model Application No. H9-5755

Patent Document 2: Utility Model Application No. H5-33457

Patent Document 3: Utility Model Application No. S59-184026

Patent Document 4: Patent Application No. H4-348155

### DISCLOSURE OF INVENTION

### Problem to be Solved by the Invention

However, in the conventional body-felt sound seat, a sound field is formed posterior to the head of a person seated in the body-felt sound seat. Hence, the seated person hears the sound coming from backside, which is considered unnatural. Moreover, among the vibrations of a low-frequency sound transmitted at the back and the hips, the vibrations at the back are considered unnatural and fail to provide comfort. Because the body-felt sound seat is configured in such a way that the mechanical vibrations of the low-frequency sound are first generated in the vibrator and then directly transmitted to the seated person, efficiency in reproducing the low-frequency sound that is valuable in a body-felt sound effect is poor.

The present invention has been achieved to solve the above problems in the conventional technology and it is an object of the present invention to provide a speaker-embeddable seat that achieves high efficiency in reproducing low-frequency sound and provides comfort to a seated person, and a personal audio system that uses the speaker-embeddable seat.

### Means for Solving Problem

### BRIEF DESCRIPTION OF DRAWINGS

FIG. 1-1 is an external view for depicting a configuration of a speaker-embeddable seat according to a first embodiment of the present invention.

FIG. 1-2 is a diagram of an internal frame structure of FIG. 1-1.

FIG. 1-3 is a cross section taken along line A-A of FIG. 1-1.

FIG. 1-4 is a cross section taken along line B-B of FIG. 1-1.

FIG. 1-5 is a side cross section of FIG. 1-1.

FIG. 2 is a schematic diagram of a personal audio system according to a second embodiment of the present invention.

FIG. 3 is a diagram depicting an example of an audio processing circuit of the personal audio system according to the second embodiment.

FIG. 4 is a schematic diagram of a personal audio system according to a third embodiment of the present invention.

FIG. 5 is a diagram depicting an example of an audio processing circuit of the personal audio system according to the third embodiment.

### EXPLANATIONS OF LETTERS OR NUMERALS

1 Speaker-embeddable seat
2 Seat portion
3 Backrest
4 Mesh seat-cover
5 Sound-insulating material
6R, 6L Speaker
7 Frame
8 Cushion
9 Spacer member
10 Woofer
11 Woofer unit
12 Woofer box
20 Duct
71, 72 Sidepiece
73a, 73b, 73c Pipe
74 Speaker fixing unit
100 Center front speaker CF
101 Mixer
102, 103, 104 BPF
105, 106 Delay circuit
107 Mixer
200R Front right speaker FR
200L Front left speaker FL
201 Mixer
202, 203, 204 BPF
205, 206 Delay circuit

### BEST MODE(S) FOR CARRYING OUT THE INVENTION

Exemplary embodiments of the present invention are explained in detail below. The present invention is not limited to the embodiments described below. Although the invention has been described with respect to specific embodiments for a complete and clear disclosure, the appended claims are not to be thus limited but are to be construed as embodying all modifications and alternative constructions that may occur to one skilled in the art which fairly fall within the basic teaching herein set forth.

### FIRST EMBODIMENT

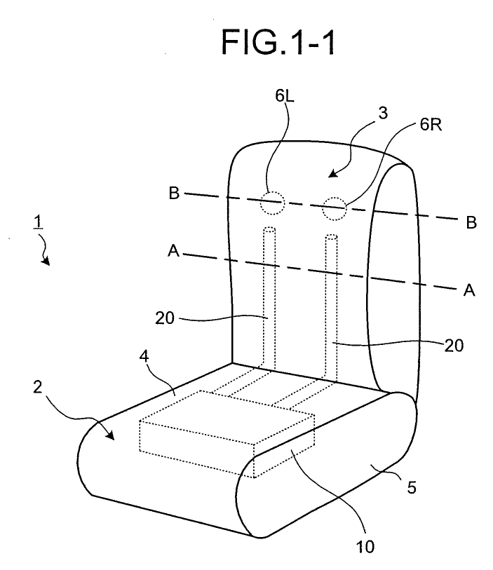

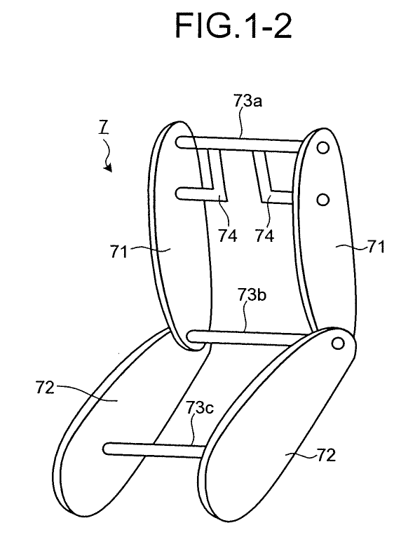

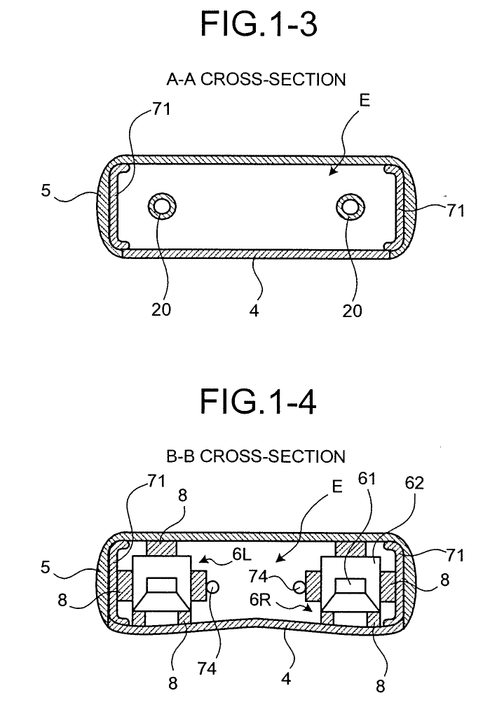

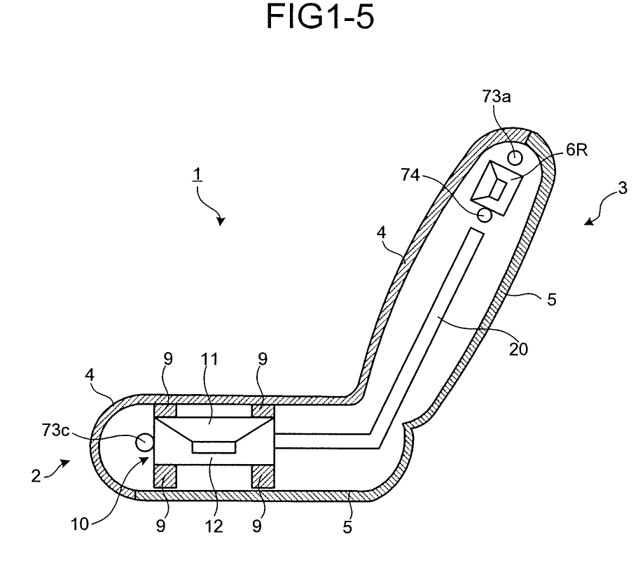

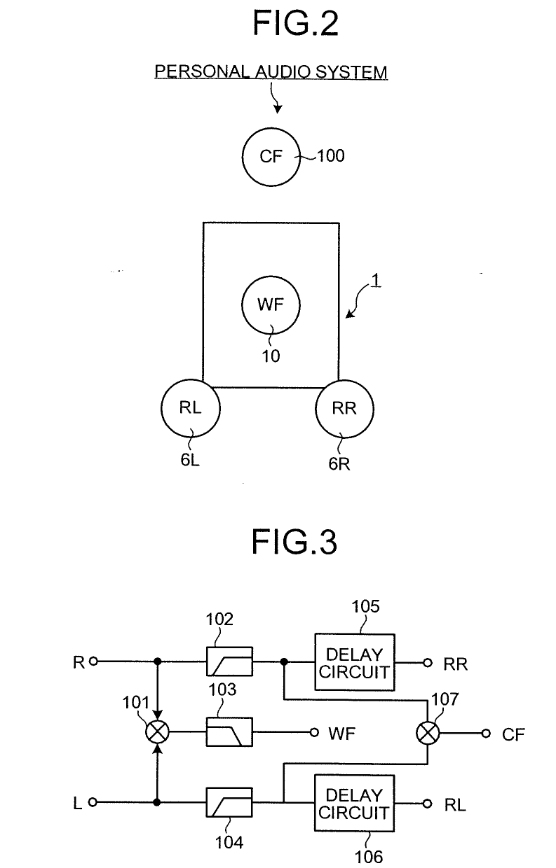

FIG. 1 is a diagram for explaining about a speaker-embeddable seat 1 according to a first embodiment of the present invention. FIG. 1-1 is an external view for depicting a configuration of the speaker-embeddable seat 1 according to the first embodiment. FIG. 1-2 is a diagram of an internal frame structure of FIG. 1-1. FIG. 1-3 is a cross section taken along line A-A of FIG. 1-1. FIG. 1-4 is a cross section taken along line B-B of FIG. 1-1. FIG. 1-5 is a side cross section of FIG. 1-1.

As shown in FIG. 1-1, the speaker-embeddable seat 1 according to the first embodiment includes a seat portion 2 and a backrest 3. A mesh seat-cover 4 [d] (also referred to as a mesh seat) covers the seating surface of the seat portion 2, while a sound-insulating material 5 (also referred to as an insulating seat) covers the sidepieces and the bottom surface of the seat portion 2. A woofer 10 (a speaker for reproducing low-frequency sound) is embedded in the seat portion 2. A pair of ducts 20 is connected to the woofer 10 and configured to extend in the backrest 3 up to a position below a speaker 6R and a speaker 6L arranged in the backrest 3. As described above, the ducts 20 are used as a conduit line for the woofer 10. However, any other member such as a pipe can be used that can function as the conduit line for the woofer 10.

The mesh seat-cover 4 also covers the front surface of the backrest 3, while the sound-insulating material 5 also covers the sidepieces and the rear surface of the backrest 3. In the backrest 3, the speakers 6R and 6L that reproduce middle-to-high frequency sound are arranged near to the ears of a seated person. As described above, the ducts 20 extend up to the position below the speakers 6R and 6L, and near to the ears of the seated person. The speakers 6R and 6L are supported by an elastic material described below so that the speakers 6R and 6L are movable back and forth.

The mesh seat-cover 4 and the sound-insulating material 5 are supported by a frame 7 shown in FIG. 1-2, and are wrapped around the frame 7[r] are wrapped around a frame 7 shown in FIG. 1-2. The mesh seat-cover 4 can be made of a three-dimensional knitted fabric such as Toray (R) or Fusion (R) (http://www1.ex.asahi-kasei.co.jp/txpt/txm/ja/fusion/layer1/feature_ja.html)[r] Fusion (R) produced by Asahi Kasei Fibers Corporation (http://www.asahi-kasei.co.jp/fibers/fusion/index.html). The three-dimensional knitted fabric has a bow-like connecting fiber that connects an upper honeycomb mesh and a lower honeycomb mesh, and functions as a spring thereby maintaining superior body pressure dispersion. Moreover, because the air can freely pass through the mesh structure and the connecting fibers, the three-dimensional knitted fabric provides superior ventilation. The sound insulating-material 5 can be made of either a sound-insulating fabric, leather, a polyester bonded fabric, or an artificial leather. The mesh seat-cover 4 and the sound-insulating material 5 are made to be flexible in nature.

The frame 7 includes a pair of sidepieces 71, a pair of sidepieces 72, pipes 73a, 73b, and 73c connecting the pairs of sidepieces 71 and 72, and a pair of substantially L-shaped speaker fixing units 74 that restrict up-down movement of the speakers 6R and 6L.

As shown in FIGS. 1-3 to 1-5, there is a large inner space E (hollow area) that is defined by the mesh seat-cover 4 and the sound-insulating material 5. The speakers 6R and 6L, and the ducts 20 are arranged in the inner space E. The inner space E is large enough to accommodate a large-size speaker. The speakers 6R and 6L include a speaker unit 61 that outputs the sound and a flexible speaker box 62 made of resin that houses the speaker unit 61.

More particularly, the speakers 6R and 6L are arranged in the space surrounded by the pair of sidepieces 71, the pipe 73a, and the speaker fixing units 74. The up-down movement of the speakers 6R and 6L is restricted by the speaker fixing units 74 and the pipe 73a. The size of the speaker fixing units 74 depends on the size of speakers to be used. The sides of the speakers 6R and 6L are supported by a cushion 8 that is elastic in nature so that the speakers 6R and 6L are movable sideways. The cushion 8 is provided between the pair of sidepieces 71 of the frame 7 and the corresponding sides of the speakers 6R and 6L, and between the speaker fixing units 74 and the other corresponding sides of the speakers 6R and 6L. The front side and the rear side of the speakers 6R and 6L are supported by the cushion 8 so that the speakers 6R and 6L are movable back and forth. The cushion 8 is provided between the mesh seat-cover 4 and the front sides of the speakers 6R and 6L, and the sound-insulating material 5 and the rear sides of the speakers 6R and 6L.

When a person sits on the seat portion 2 and rests the back on the backrest 3 of the speaker-embeddable seat 1 described above, the mesh seat-cover 4 flexes, causing the cushion 8 to elastically deform. Because the positions of the speakers 6R and 6L move backward due to the elastic deformation of the cushion 8, the seated person does not come in direct contact with the speakers 6R and 6L, which makes the speaker-embeddable seat 1 comfortable to sit in.

As shown in FIG. 1-5, the woofer 10 arranged in the seat portion 2 includes a woofer unit 11 and a woofer box 12 that houses the woofer unit 12[r] the woofer unit 11. The woofer box 12 has an opening through which the pair of ducts 20 that are made of resin is connected to the woofer 10 and extends up to the position below the speakers 6R and 6L, and near to the ears of the seated person. Preferably, the woofer box 12 and the ducts 20 are made of a flexible material. The pipe 73c is fixed to the front side of the woofer 10, while the top side and the bottom side of the woofer 10 are supported by a spacer member 9. The seating surface of the seat portion 2 vibrates when the vibrations output from the woofer 10 are transmitted to the mesh seat-cover 4 via the spacer member 9. The mechanism to transmit vibrations of the woofer 10 to the seating surface is not limited to the mechanism shown in FIG. 1-5. For example, a vibration-transmitting plate that has superior vibration transmission property can be arranged between the woofer 10 and the mesh seat-cover 4.

In the speaker-embeddable seat 1, middle-to-high frequency sound is reproduced by the speakers 6R and 6L that are arranged in the backrest 3 near to the ears of the seated person. The low-frequency vibrations output from the woofer 10 are directly transmitted to the seated person from beneath the seating surface, while the low-frequency sound output from the woofer 10 is reproduced in the backrest 3 near to the ears of the seated person via the ducts 20. That is, the low-frequency sound waves that cannot be heard by the human ear are transmitted from the woofer 10 directly to the seated person by forcing the mesh seat-cover 4 to vibrate, and the low-frequency sound waves that can be heard by the human ear are transmitted via the ducts 20 near to the ears of the seated person. The sound waves of middle-to-high frequency sound are transmitted through the mesh seat-cover 4 near to the ears of the seated person. As a result, for example, when this mechanism is used in a driver's seat, a driver alone can listen to music at loud volume or hear messages without disturbing fellow passengers. Listening to music at loud volume can help the driver shake off drowsiness while driving.

As described above, according to the first embodiment, the woofer 10 is arranged inside the seat portion 2. The ducts 20 that extend in the backrest 3 up to a position near to the ears of the seated person are connected to the woofer 10. The low-frequency sound output by the woofer 10 is transmitted via the ducts 20 to the ears of the seated person. As a result, low-frequency sound can be reproduced efficiently while a person can be seated in comfort. Because the low-frequency sound waves are effectively transmitted from the seating surface to the seated person, and the low-frequency sound waves that can be heard by the human ear are reproduced near to the ears of the seated person via the ducts 20, efficiency in reproducing low-frequency sound can be improved. Moreover, because only the hips are vibrated without the back being vibrated, the body is not subjected to over-vibration, which allows comfort for the seated person.

According to the first embodiment, because the speakers 6R and 6L for reproducing middle-to-high frequency sound are arranged near to the ears of the seated person in the backrest 3, the seated person can hear the middle-to-high frequency sound from a position near to the ears. Moreover, because the mesh seat-cover 4 covers the seating surface of the seat portion 2 and the front surface of the backrest 2[r] the backrest 3, the air and the sound can freely pass through the mesh structure. Because the sound-insulating material 5 covers the rear surface of the backrest 3, high sound insulation is achieved with less leakage of sound. Thus, the seated person can listen to a loud sound even at less volume with effective audio output.

### SECOND EMBODIMENT

A second embodiment of the present invention is described below with reference to FIGS. 2 and 3. A personal audio system according to the second embodiment provides a comfortable audio environment by using the speaker-embeddable seat 1 according to the first embodiment.

FIG. 2 is a schematic diagram of the personal audio system according to the second embodiment. As shown in FIG. 2, the personal audio system according to the second embodiment includes a center front speaker (CF) 100 arranged anterior to the speaker-embeddable seat 1. The center front speaker (CF) 100 can be arranged at any place as long as it is anterior to the speaker-embeddable seat 1. For example, in case of a car, the center front speaker (CF) 100 can be located near the front roof or at the center of the steering wheel. The speaker 6R and the speaker 6L in the speaker-embeddable seat 1 is used as a rear right speaker RR and a rear left speaker RR[r] a rear left speaker RL, respectively.

FIG. 3 is a diagram showing an audio processing circuit of the personal audio system according to the second embodiment. As shown in FIG. 3, the audio processing circuit includes a mixer 101, BPFs 102, 103, and 104, delay circuits 105 and 106, and a mixer 107.

The audio processing circuit shown in FIG. 3 receives R and L signals from a sound source such as a CD player, a DVD player, and a MD player. The R signals are input to the mixer 101 and the BPF 102, while the L signals are input to the mixer 101 and the BPF 104.

The mixer 101 mixes the received R and L signals, and outputs the mixed signals to the BPF 103. The BPF 103 removes, from the signals received from the mixer 101, frequency components of 400 Hz or above (middle-to-high frequency components) and outputs resultant signals to a woofer WF.

The BPF 102 removes, from the received R signals, frequency components of 200 HZ or less (low-frequency components), and outputs resultant signals to the delay circuit 105 and the mixer 107. The delay circuit 105 delays the R signals received from the BPF 102 by a predetermined time (for example, 5 to 10 msec) and outputs the delayed signals to a rear right speaker RR.

The BPF 104 removes, from the received L signals, frequency components of 200 HZ or less (low-frequency components), and outputs resultant signals to the delay circuit 106 and the mixer 107. The delay circuit 106 delays the L signals received from the BPF 104 by a predetermined time (for example, 5 to 10 msec) and outputs the delayed signals to a rear left speaker RL.

The mixer 107 mixes the R signals and the L signals received from the BPF 102 and the BPF 104, respectively, and outputs the mixed signals to a center front speaker CF.

According to the second embodiment, the audio signals that are to be output from the center front speaker CF, the rear right speaker RR, and the rear left speaker RL are subjected to reverberation processing and frequency characteristic conversion so that a sound image is localized anterior to the head of a person seated in the seat. Hence, a comfortable personal audio environment can be provided to the person seated in the speaker-embeddable seat 1.

### THIRD EMBODIMENT

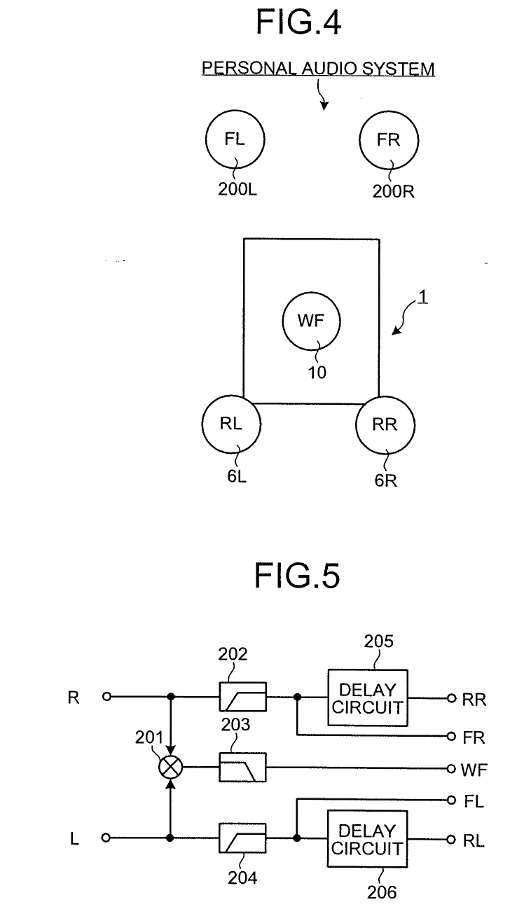

A third embodiment of the present invention is described below with reference to FIGS. 4 and 5. A personal audio system according to the third embodiment provides a comfortable audio environment by using the speaker-embeddable seat 1 according to the first embodiment.

FIG. 4 is a schematic diagram of the personal audio system according to the third embodiment. As shown in FIG. 4, the personal audio system according to the third embodiment includes a front right speaker (FR) 200R and a front left speaker (FL) 200L arranged anterior to the speaker-embeddable seat 1. The front right speaker (FR) 200R and the front left speaker (FL) 200L can be arranged at any place as long as they are anterior to the speaker-S embeddable seat 1. For example, the front right speaker (FR) 200R and the front left speaker (FL) 200L can be located on the front side of the armrests of the speaker-embeddable seat 1. The speakers 6R and 6L in the speaker-embeddable seat 1 are used as a rear right speaker RR and a rear left speaker RL respectively.

FIG. 5 is a diagram showing an audio processing circuit of the personal audio system according to the third embodiment. As shown in FIG. 5, the audio processing circuit includes a mixer 201, BPFs 202, 203, and 204, and delay circuits 205 and 206.

The audio processing circuit shown in FIG. 5 receives R and L signals from a sound source such as a CD player, a DVD player, and a MD player. The R signals are input to the mixer 201 and the BPF 202, while the L signals are input to the mixer 201 and the BPF 204.

The mixer 201 mixes the R and L signals that are received, and outputs the mixed signals to the BPF 203. The BPF 203 removes, from the signals received from the mixer 201, frequency components of 400 Hz or above (middle-to-high frequency components) and outputs resultant signals to a woofer WF.

The BPF 202 removes, from the received R signals, frequency components of 200 HZ or less (low-frequency components), and outputs resultant signals to the delay circuit 205 and a front right speaker FR. The delay circuit 205 delays the R signals received from the BPF 202 by a predetermined time (for example, 5 to 10 msec) and outputs the delayed signals to a rear right speaker RR.

The BPF 204 removes, from the received L signals, frequency components of 200 HZ or less (low-frequency components), and outputs resultant signals to the delay circuit 206 and a front left speaker FL. The delay circuit 206 delays the L signals received from the BPF 204 by a predetermined time (for example, 5 to 10 msec) and outputs the delayed signals to a rear left speaker RL.

According to the third embodiment, the audio signals that are to be output from the front right speaker FR, the front left speaker FL, the rear right speaker RR, and the rear left speaker RL are subjected to reverberation processing and frequency characteristic conversion so that a sound image is localized anterior to the head of a person seated in the seat. Hence, a comfortable personal audio environment can be provided to the person seated in the speaker-embeddable seat 1.

### INDUSTRIAL APPLICABILITY

A speaker-embeddable seat and a personal audio system according to the present invention are suitable for implementing in all types of seats (body-felt sound system) such as in a vehicle seat, a living-room seat, and a relaxation seat.

1-5. (canceled)

6. A speaker-embeddable seat comprising:
a seat portion that includes a seat and a backrest; and
a speaker portion that includes
a woofer that is configured to output low-frequency sound and is arranged in the seat; and
an audio path that acoustically couples the woofer to a position in the backrest that is near ears of a person seated in the seat, wherein
a seating surface of the seat and a first surface of the backrest are covered by a mesh sound-transparent material, the first surface being adjacent to the seating surface, and
a second surface of the backrest is covered by a sound-insulating material, the second surface being opposite to the first surface.

7. The speaker-embeddable seat according to claim 6, further comprising a speaker that is configured to output middle-frequency to high-frequency sound and is arranged in the backrest at a position near ears of a person seated in the seat.

8. The speaker-embeddable seat according to claim 6, wherein the mesh sound-transparent material is a three-dimensional knitted fabric.

9. A personal audio system comprising:
a speaker-embeddable seat that includes a seat portion and a speaker portion, the seat portion including a seat and a backrest, and the speaker portion including
a first speaker that is configured to output low-frequency sound and is arranged in the seat;
a second speaker that is configured to output middle-frequency to high-frequency sound and is arranged in the backrest at a position near ears of a person seated in the seat; and
an audio path that acoustically couples the first speaker to a position in the backrest that is near ears of a person seated in the seat; and
a front speaker that is located anterior to a person seated in the seat, wherein
a seating surface of the seat and a first surface of the backrest are covered by a mesh sound-transparent material, the first surface being adjacent to the seating surface,
a second surface of the backrest is covered by a sound-insulating material, the second surface being opposite to the first surface,
the first speaker, the second speaker, and the front speaker form a sound field, and
audio signals that are to be output from the front speaker and the second speaker are subjected to reverberation processing and frequency characteristic conversion so that a sound image generated in the sound field is localized anterior to head of a person seated in the seat.
